(19) United States
(12) Patent Application Publication
(10) Pub. No.: US 2010/0122653 A1
(43) Pub. Date: May 20, 2010

(54) Guadua Flagpole for Flag Raising with Inner Compartment on Same Pole for Storing the Flag

(76) Inventor: Jorge Ivan Diaz-Ortiz, Miami, FL (US)

Correspondence Address: ROBERT M. SCHWARTZ, P.A., P.O. BOX 221470, HOLLYWOOD, FL, 33022, US

(21) Appl. No.: 12/620,171

(22) Filed: Nov. 17, 2009

(30) Foreign Application Priority Data
Nov. 19, 2008 (CO) 08122945

(51) Int. Cl. G09F 17/00

(52) U.S. Cl. 116/173

(57) ABSTRACT

A flagpole formed of the guadua plant has an interior cavity for storing a flag.

### INDEX TO RELATED APPLICATIONS

This application claims the benefit of Colombian National Application No. 08-122945 filed Nov. 19, 2009 the disclosure of which is incorporated herein by reference in its entirety.

### BACKGROUND OF THE INVENTION

The present invention is a flagpole formed of a guadua tree.

### BRIEF SUMMARY OF THE INVENTION

A flagpole, with its respective elements to raise a flag, is made of the guadua tree. The guadua tree is a natural product and grows in jungle areas in Latin America. Guadua poles are easy to obtain. The guadua tree exhibits good physical and mechanical properties making it suitable for flagpole use. The guadua tree is able to resist outdoor weather for many years and has a density (weight/volume) of approximately 0.829 gm/cm3, in comparison to iron, which has a density of 7.8 9,/Cm3, meaning, guadua poles are lightweight in comparison.

Guadua poles have lengths ranging between 2 to 20 meters and maximum diameter 25 cm.

In one embodiment, the guadua flagpole has a compartment that is constructed in the trunk of the guadua plant. The compartment or cavity is constructed at a height that is suitable for manipulation by a normal person, such as about 3-5 feet above the ground. The flagpole also has a door made of a piece of guadua trunk or wood. The door has hinges and a frame with a cavity to store a flag after rolling.

This invention is related to the utilization of the guadua poles for displaying the flag, because, patriotic fervor calls for the nation's symbols in every country or nation by citizens. The flag has particular importance as the symbol of a nation, when a national holiday is being held and no pole is available. People simply display the flag by the door or window of a dwelling or house. Flags placed in this way are easily lost and, as a result, when the next national holiday comes around, people will simply decide not to display a flag.

A flag is typically placed on a metal flag holder or flagpole that takes up a space to install. The present invention uses a natural element for the flagpole. This is the guadua angustlfolia, which is a botanical species of the family of the grassy bamboo family. This plant has its habitat in moist tropical jungles or on river banks. It grows naturally in jungles in Latin America and a many countries in Asia.

Guadua is a rhizomatome perennial and is an erect plant at the base. Its stalks range in length between 6 and 20 meters, which experiences a growth in length some 10 to 20 meters in 120 days and reach a 20 cm diameter. It becomes usable some 4 or 5 years after planting.

Ideal altitude for guadua cultivation is 400 to 1200 above sea level. Guadua is outstanding in its genre for its physical and mechanical properties, as well as its length, that may reach 300 meters, with diameter ranging between 20 and 30 cm. Guadua has been selected as one of the best of the bamboo family thanks to its energy-absorption capability and its great flexibility, which make it ideal as a natural material to be used in construction projects.

Two varieties of guadua are commonly known. The guadua varieties are guadua angustifolia varbicolor and guadua angustifolia varnigra. The varbicolor variety has a green trunk with green stripes, while the varnigra variety features a green trunk, with a shade of black.

In popular parlance, guadua is known and depending on regional usages guadua is known as “caña brava, caña mansa, or caña guadua.

The guadua brava is very useful as a flagpole, because in can be planted in the soil by simply digging a hole deep enough to match pole length. The portion of the pole to be buried may be covered with tar or mortar. In addition, a metal structure is constructed to serve as pole-bearer, depending on local characteristics such as soils, climate and environmental legislation.

This FLAGPOLE may be at least 2 meters in length arid a maximum of 20 meters in length. A flagpole may be used to raise several flags. One flag would be placed on top and the others below it.

This invention relating to the utilization of the guadua trunk as a flagpole and, besides, constructing compartments by using the guadua trunks to roll, store the flag and keep it always available to be raised and later take it down and store It in the compartment. The flap is securely stored in the compartment and provides us with a practical way of holding a flag for display on national holidays.

This compartment, or cavity, which is made with guadua trunks of the same type as the compartment, as shown in FIG. 1, is placed at a normal height, so it can be handled by a person of average height. The compartment door is, again, constructed out of the guadua trunk. It has a bent over 26 gauge reinforcement with a zinc-covered metal sheet (0.50 mm thick) that doubles as a frame (see FIG. 2, detail 1). Likewise, the opening inside the guadua trunk has a frame with the same characteristics as the metal sheet frame.

The door is joined to the structure by means of two hinges, as per FIG. 2. The arrangement provides for an airtight closure.

As a result, this flagpole has the elements necessary for flag-raising, such as: it is usable for raising a variety of materials and sizes. Strings or chords may be used, as well as rings, an idler pulley and, on top of the pole, a base is installed to support an icon such as an eagle, a spear point, a sphere, etc.

In one embodiment, the flagpole of the present invention comprises;

a. a main body of a flagpole from a guadua tree having a first end and a second end;

b. a cavity on a portion of said main body constructed and arranged to store a flag.

The flagpole has a height between about 2-10 meters in length and a diameter of about 20 cm. Preferably, the flagpole of first end is buried in soil and secured with tar or mortar covering said buried first end.

The flagpole has a cavity formed in said the body and the cavity has an opening accessible from outside said main body.

The cavity has an opening is covered with a hinged door.

A reel constructed and arranged for receiving a flag is positioned within the cavity.

### BRIEF DESCRIPTION OF THE DRAWINGS

FIG. 1 is a disconnected side view of sections of the invention.

FIG. 2 is a side view of the flagpole cavity and door access.

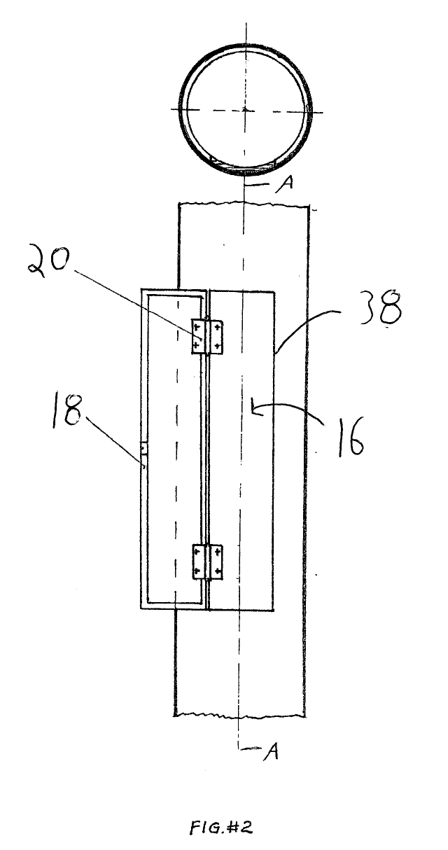

FIG. 3 is a partial side cross section of the cavity along line A-A from FIG. 2 showing an internal reel placed in the cavity.

### DETAILED DESCRIPTION OF THE PREFERRED EMBODIMENT

Flagpole 10 has a first end 12 and a second end 14. A cavity 16 is formed in a section of pole 10. Cavity 16 is accessed through opening 38 on the surface of pole 10. Cavity 16 has door 18 that is attached with hinges 20 on pole 10. First end 12 is placed below the surface of the ground 22 and secured into position with securing material 24. Material 24 is tar, mortar, or other suitable material for securing pole 10 into a fixed position.

Pole 10 has affixed thereto a cord holder 26 used for securing cord 28 that supports and holds flag 36. Pole 10 has cord idler pulley 30 affixed near second end 14. A user can move cord 28 through pulley 30 to raise and lower flag 36 as is commonly known.

Pole 10 has icon base 32 on second end 14 and icon base 32 supports icon 34.

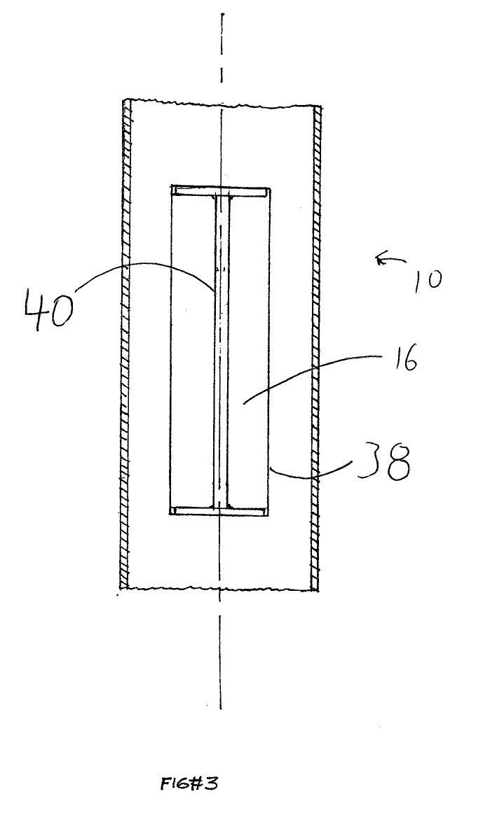

As seen in FIG. 3, reel 40 is within cavity 16 and is used to wrap flag 36 such that flag 35 is stored in cavity 16.

In use, a user opens door 18 to access cavity 16 through opening 38. Flag 36 is folded and wrapped around reel 40. Door 18 is closed and flag 36 is stored in pole 10.

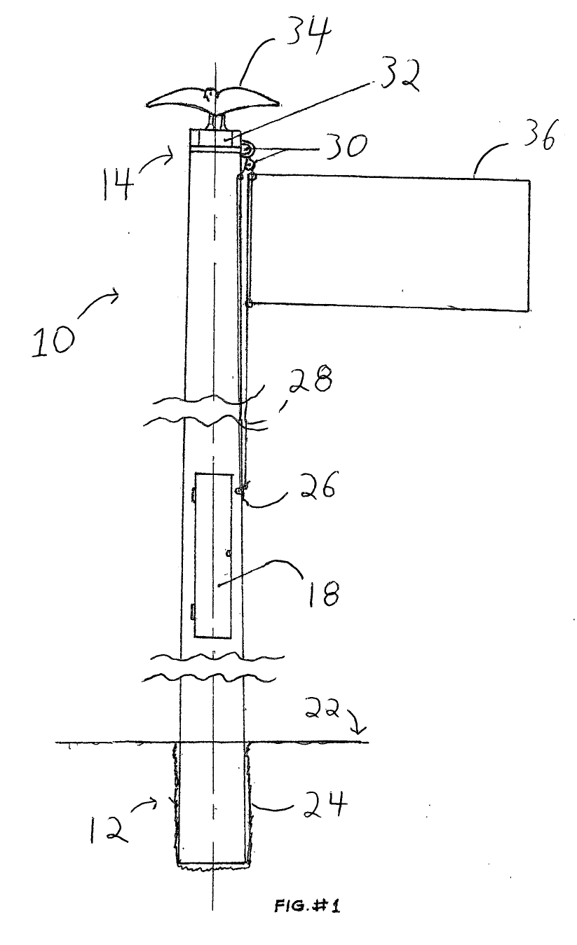

When the flag is needed, a user opens door 18 to access cavity 16 and remove flag 36 from reel 40. Flag 18 is then secured to cord 28 in any appropriate manner as known in the art. Cord 28 is moved through pulley 30 such that flag 36 is raised to the desired height on flag pole 10. Although FIG. 1 shows flag 36 at the top of flag pole 10, cord 28 may be stopped and secured at any desired height by securing cord 28 to cord holder 26 in a manner as is known in the art.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A flagpole comprising;
a. a main body of a flagpole from a guadua tree having a first end and a second end;
b. a cavity on a portion of said main body constructed and arranged to store a flag.

2. The flagpole of claim 1 wherein said guadua tree is between 2-10 meters in length.

3. The flagpole of claim 1 wherein said first end is buried in soil and secured with tar or mortar covering said buried first end.

4. The flagpole of claim 1 wherein said cavity formed in said main body.

5. The flagpole of claim 1 wherein said cavity has an opening accessible from outside said main body.

6. The flagpole of claim 1 wherein said cavity has an opening accessible from outside said main body and said opening is covered with a hinged door.

7. The flagpole of claim 1 wherein a reel constructed and arranged for receiving a flag is positioned within said cavity.
